(19) United States
(12) Patent Application Publication
(10) Pub. No.: US 2026/0188777 A1
(43) Pub. Date: Jul. 2, 2026

(54) BATTERY PACK SYSTEM WITH MULTILAYER COOLING STRUCTURE OF POWER RELAY ASSEMBLY

(71) Applicants: HYUNDAI MOTOR COMPANY, SEOUL (KR); KIA CORPORATION, SEOUL (KR)

(72) Inventors: Hyojin Jin, Hwaseong-si (KR); Kyung Ho Kim, Hwaseong-si (KR)

(73) Assignees: HYUNDAI MOTOR COMPANY, SEOUL (KR); KIA CORPORATION, SEOUL (KR)

(21) Appl. No.: 19/197,297

(22) Filed: May 2, 2025

(30) Foreign Application Priority Data
Dec. 30, 2024 (KR) 10-2024-0200178

(51) Int. Cl. H01M 10/653; H01M 10/42; H01M 10/613; H01M 10/625; H01M 10/6554; H01M 10/6556; H01M 50/262; H01M 50/271; H01M 50/507; H01M 50/586

(52) U.S. Cl. CPC H01M 10/653; H01M 10/425; H01M 10/613; H01M 10/625; H01M 10/6554; H01M 10/6556; H01M 50/262; H01M 50/271; H01M 50/507; H01M 50/586

(57) ABSTRACT

A battery pack system includes a cooling module provided on at least a portion of an outer surface of a battery housing. The cooling module includes cooling plates. The battery pack system also includes: a power relay assembly coupled to the battery housing so that a predetermined area or more of a surface of the power relay assembly comes into contact with the cooling plates; and a main pad interposed between the power relay assembly and the cooling plates. The main pad includes an insulator formed of a material having high thermal conductivity.

### CROSS-REFERENCE TO RELATED APPLICATION(S)

This application claims the benefit of and priority to Korean Patent Application No. 10-2024-0200178, filed on Dec. 30, 2024, in the Korean Intellectual Property Office, the disclosure of which is herein incorporated by reference in its entirety.

### TECHNICAL FIELD

The present disclosure relates to a battery pack system with a multilayer cooling system applied to a power relay assembly (PRA). More particularly, the present disclosure relates to a battery pack system in which main heat generators of a power relay assembly are configured to be located toward an upper cooling plate and a lower cooling plate basically provided in a battery pack, and thermal and electric insulation members are disposed in a plurality of layers to increase thermal insulation efficiency and prevent deterioration of an electric insulation effect.

### BACKGROUND

Battery pack systems of electric vehicles are in a technical field that desires both stability and efficiency. Particularly, the battery pack of an electric vehicle handles high-voltage power and effectively performs power transmission with various related systems, including a driving system and a charging system.

For this purpose, the battery pack system of an electric vehicle is provided with a power relay assembly (PRA). The power relay assembly controls high-voltage current. The power relay assembly supplies high-voltage power to a system that requires high-voltage power when needed, and cuts off the supply of the high-voltage power when needed.

The power relay assembly serves to connect a battery to a charging system when charging the battery, and safely cuts off the connection therebetween when charging is completed.

Even if electrical energy is supplied for direct current (DC) high-speed charging or alternating current (AC) charging during the charging process, the power relay assembly manages inflow and outflow of high-voltage current depending on each situation.

In addition, a fuse system configured to interrupt high-voltage overcurrent may safely interrupt a circuit in a sudden short circuit or overload situation.

The power relay assembly is an apparatus for efficiently and safely managing inflow and outflow of high-voltage current. The system includes a busbar unit that allows high-voltage current to flow stably or a relay unit that supplies or blocks high-voltage current and controls the flow of high-voltage current, as main core components.

Because the busbar unit and the relay unit perform a role of applying or blocking the flow of high-voltage current, each of the busbar unit and the relay unit or a portion in which the busbar unit and the relay unit are coupled to each other is a position where heat is generated most frequently in the power relay assembly. As a result, careful management including cooling is desired.

A separate cooling device is commonly installed in the power relay assembly; however, this increases weight and poses challenges due to limited installation space.

Therefore, technology to solve these problems is desired.

### SUMMARY

The present disclosure has been made in view of the above problems, and it is an object of the present disclosure to solve the problem noted above in which separate cooling equipment had to be installed to release and dissipate heat generated from a power relay assembly.

It is another object of the present disclosure to solve the problem in which the volume and weight of a power relay assembly were increased due to cooling equipment equipped therein.

It is yet another object of the present disclosure to solve the problem in which it was difficult to secure durability and stability of equipment, which handles electrical energy, including electric batteries, as performance of the electric batteries and electric driving motors improved and higher-voltage current had to be repeatedly handled for rapid charging.

The objects of the present disclosure are not limited to the above-described contents, and other objects and tasks that were not mentioned herein should be understood by the following description.

In accordance with the present disclosure, the above and other objects can be accomplished by the provision of a battery pack system described herein. The battery pack system includes a cooling module provided on at least a portion of an outer surface of a battery housing. The cooling module includes cooling plates. The battery pack system also includes a power relay assembly coupled to the battery housing so that a predetermined area or more of a surface of the power relay assembly comes into contact with the cooling plates of the cooling module. The battery pack system also includes a main pad interposed between the power relay assembly and the cooling plates. The main pad includes an insulator formed of a material having high thermal conductivity.

The power relay assembly may include a main cover configured to have a hollow rectangular parallelepiped shape and an open lower surface. The power relay assembly may also include an insulating plate coupled to a lower end of the main cover to close the open lower surface of the main cover. The insulating plate is formed of an insulator. The main pad may have a predetermined thickness and is interposed between the cooling plates and a lower surface of the insulating plate.

The battery housing may include: a base plate configured to have a lower surface; a plurality of battery modules coupled to predetermined positions on an upper surface of the base plate; and a cover plate configured to cover upper portions of the plurality of battery modules to form an upper surface corresponding to the base plate. The battery housing may also include an upper cooling plate configured as one of the cooling plates of the cooling module, and formed with a predetermined area along an upper surface of the cover plate. The power relay assembly may be coupled to an upper surface of the upper cooling plate so that the lower surface of the insulating plate faces the upper cooling plate.

The power relay assembly may further include: busbar units configured such that at least a portion of each busbar unit is accommodated in the main cover, and arranged along a path in a predetermined direction; a main relay coupled to an inside of the main cover and configured to control a flow of high-voltage power through the busbar units; and a plurality of release pads provided on an upper surface of the insulating plate to form an insulating layer of a predetermined size, and formed of a material having high thermal conductivity.

The busbar units may be placed in contact with upper surfaces of the plurality of release pads disposed on the upper surface of the insulating plate, so as to be disposed at a lower height toward the upper cooling plate in a biased manner in the power relay assembly.

The main relay may include a plurality of first fasteners configured to couple the main relay to the main cover to be spaced apart from an interior surface of the main cover by a predetermined distance; and a plurality of second fasteners disposed at a lower height toward the upper cooling plate in a biased manner in the power relay assembly, and provided at positions adjacent to the release pads to electrically connect the main relay and the busbar units.

A distance between the second fasteners and the upper cooling plate may be less than a distance between the first fasteners and an upper end of the main cover.

At least three insulating layers formed of an insulating material may be disposed between the second fasteners and the upper cooling plate.

The main cover may include: a heat dissipation surface configured to have a grid-shaped heat dissipation structure by thin flat plates configured to protrude from an outer surface of the main cover to intersect each other; a coupling slot in at least a portion of the outer surface; and at least one heat sink configured to be detachably coupled to the coupling slot.

Each of the cooling plates of the cooling module may have a refrigerant flow path in an inner surface thereof so that a refrigerant is flowable along a predetermined passage.

The refrigerant flow path may be configured so that a circulation path of the refrigerant within a range of an area where the power relay assembly is coupled to the refrigerant flow path to come into contact with the main pad has a higher complexity than a surrounding area.

### BRIEF DESCRIPTION OF THE DRAWINGS

The above and other objects, features, and other advantages of the present disclosure should be more clearly understood from the following detailed description taken in conjunction with the accompanying drawings, in which:

FIGS. 1 and 2 are a perspective view illustrating a battery pack system to which a multilayer cooling structure of a power relay assembly is applied according to an embodiment of the present disclosure;

FIG. 3 is a cross-sectional view schematically illustrating a structure of the battery pack system of FIG. 1 according to an embodiment of the present disclosure;

FIG. 4 is a partial perspective view illustrating the battery pack system of FIG. 1 according to an embodiment of the present disclosure;

FIG. 5 is an enlarged view illustrating a water cooling-type power relay assembly in a battery pack system according to an embodiment of the present disclosure; and

FIG. 6 is a diagram illustrating a process in which a plurality of thermal conductive layers is formed in a power relay assembly in a battery pack system according to an embodiment of the present disclosure.

### DETAILED DESCRIPTION

Hereinafter, reference should be made in detail to the embodiments of the present disclosure, examples of which are illustrated in the accompanying drawings.

Wherever possible, the same reference numbers should be used throughout the drawings to refer to the same or similar components, and repetitive descriptions thereof have been omitted.

When an element or layer is referred to as being “connected to” or “coupled to” another element or layer, it may be directly connected to or coupled to the other element or layer, or intervening elements or layers may be present.

In contrast, when an element is referred to as being “directly connected to” or “directly coupled to” another element or layer, there may be no intervening elements or layers present.

In the following description of the embodiments of the present disclosure, the terms “comprises,” “comprising,” “including,” and “having” are inclusive and therefore indicate specific features, integers, steps, operations, elements, components, and/or combinations thereof, but do not preclude the presence or addition of one or more other features, integers, steps, operations, elements, components, and/or combinations thereof.

In addition, a first direction (X-axis direction), a second direction (Y-axis direction), and a third direction (Z-axis direction) stated in the following description are used to describe a three-dimensional shape in a three-dimensional space, and indicate directions that are orthogonal to each other.

When a component, device, element, or the like of the present disclosure is described as having a purpose or performing an operation, function, or the like, the component, device, or element should be considered herein as being “configured to” meet that purpose or to perform that operation or function.

The present disclosure relates to a battery pack system 1 for electric vehicles.

The present disclosure discloses the battery pack system 1 that may improve structural stability and increase cooling efficiency while improving the structure of a power relay assembly 200 installed in the battery pack system 1 to make it simpler.

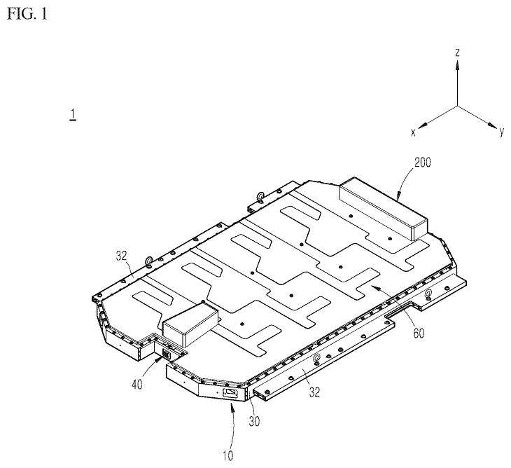

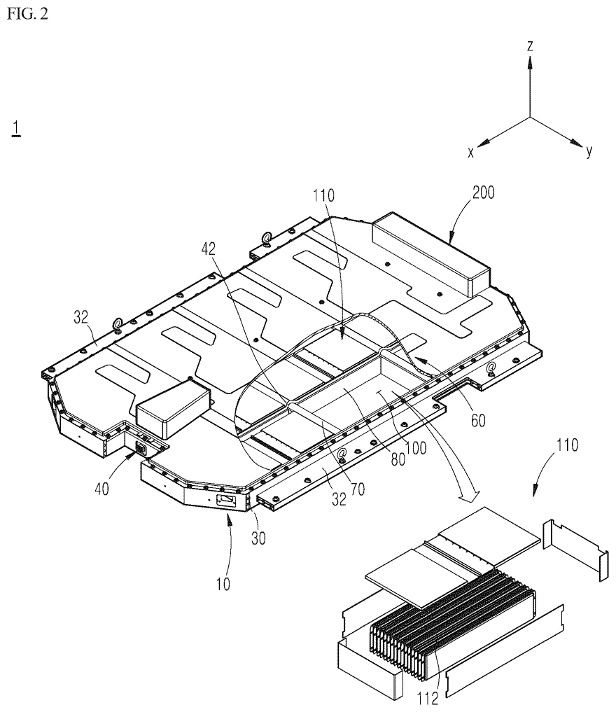

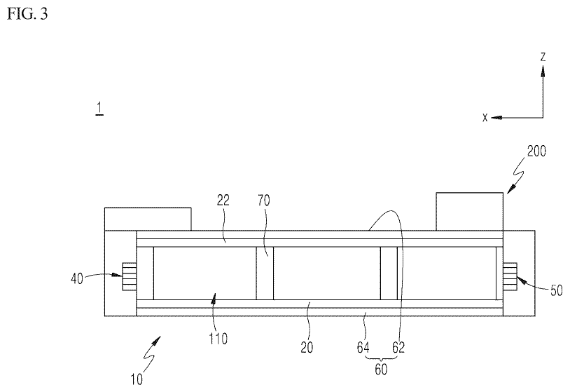

FIGS. 1 and 2 are a perspective view illustrating the battery pack system 1 to which a multilayer cooling structure of the power relay assembly 200 is applied according to an embodiment of the present disclosure. FIG. 3 is a cross-sectional view schematically illustrating the structure of the battery pack system 1 of FIG. 1 according to an embodiment of the present disclosure.

As shown in FIGS. 1 to 3, the battery pack system 1 according to an embodiment of the present disclosure has a form in which a plurality of battery modules 110 is combined in a space formed in a battery housing 10 in a predetermined pattern.

Each battery module 110 is configured such that a plurality of battery cells 112 is overlapped and combined in a stacked structure.

The battery housing 10 includes a base plate 20 that has a lower surface, and side walls 30 formed on at least a portion of the outer circumference of the base plate 20, including both edges of the base plate 20.

Several lateral members 70 and longitudinal members 80 intersect each other on the upper surface of the base plate 20 so as to form module booths 100, which are spaces formed so that the battery modules 110 may be installed respectively therein.

Each battery module 110 is installed in each respective module booth 100, where the battery module 110 is assembled and integrated. The interconnected battery modules 110 are electrically connected within the battery housing 10 to transmit and receive power through a power terminal 40 formed outside (e.g., located externally).

The battery modules 110 in the battery housing 10 are connected by a busbar or power cables 42 that are specifically manufactured. In addition, a data cable and a data terminal 50 capable of transmitting and receiving data may be further formed outside the battery housing 10.

As illustrated, the battery pack system 1 in which the plurality of battery modules 110 is combined to the battery housing 10 may be coupled to a vehicle body frame structure or a separate device through deployed coupling ends 32 that extend externally along the length of the battery housing 10.

As shown in FIG. 3, the battery housing 10, which contains the mounted battery modules 110, may be configured such that the base plate 20 and a cover plate 22 formed wide in one horizontal direction may be positioned vertically (e.g., on top of one another).

In addition, an upper cooling plate 62 and a lower cooling plate 64 may be formed on the upper surface of the cover plate 22 and the lower surface of the base plate 20, respectively, as a cooling module 60 configured to control the temperature of the battery pack system 1. Each cooling plate of the cooling plates, such as the upper cooling plate 62 and the lower cooling plate 64, may be provided on at least a portion of the surface of the upper surface of the cover plate 22 or the lower surface of the base plate 20. In some examples, only the upper cooling plate 62 or the lower cooling plate 64 may be provided depending on the embodiment to which the present disclosure is applied.

The upper cooling plate 62 and the lower cooling plate 64, i.e., the cooling plates, may be provided with a refrigerant flow path 66 formed therein so that a refrigerant may flow therein. The refrigerant flow path 66, which is formed by a predetermined passage, space, and wall within the thin cooling plate, may be configured so that a complexity of a circulation path through which the refrigerant circulates increases at a position where intensive cooling is desired, such as the power relay assembly 200. Specifically, the refrigerant flow path 66 may be densely arranged in a region of the cooling plate that is in contact with the power relay assembly 200.

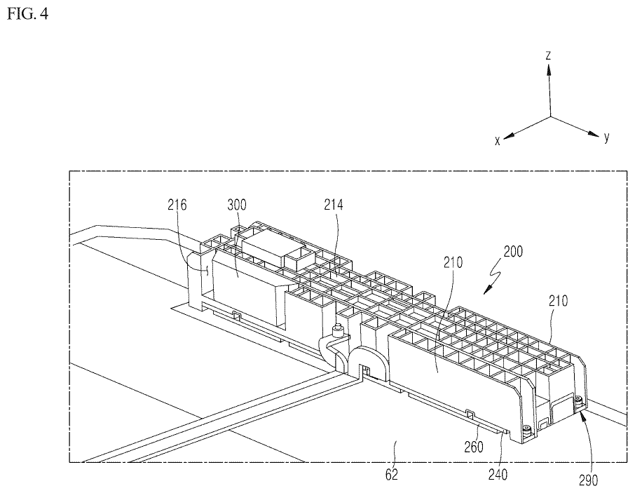

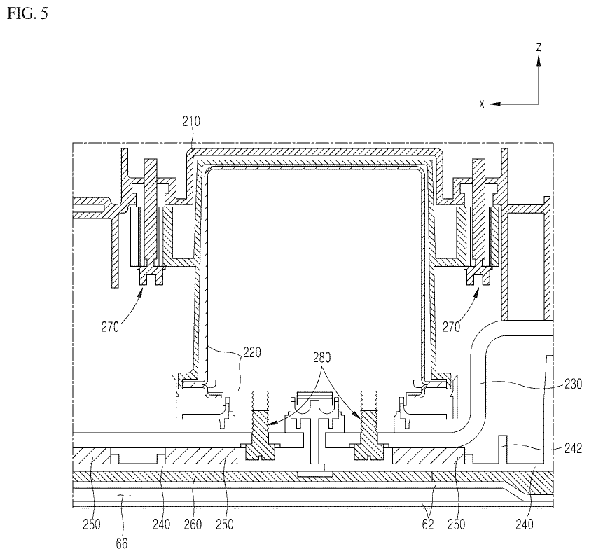

FIG. 4 is a partial perspective view illustrating the battery pack system 1 to which the multilayer cooling structure of the power relay assembly 200 is applied according to an embodiment of the present disclosure. FIG. 5 is an enlarged view illustrating the water cooling-type power relay assembly 200 in the battery pack system 1 according to an embodiment of the present disclosure.

As shown in FIGS. 3 and 4, the cooling module 60 in the battery pack system 1 according to an embodiment of the present disclosure may be provided on at least a portion of an outer surface of the battery housing 10.

Specifically, the cooling module 60 is formed with a predetermined area along the upper surface of the cover plate 22 to dissipate heat inside and outside the battery housing 10.

The power relay assembly 200 is installed on the upper cooling plate 62 provided on the upper surface of the cover plate 22.

The power relay assembly 200 includes a main cover 210, an insulating plate 240, busbar units 230, a main relay 220, heat dissipation fins 242, first fasteners 270, second fasteners 280, and third fasteners 290.

The main cover 210 has a rectangular parallelepiped structure with an empty space formed therein, and forms the outer shape of the power relay assembly 200.

The open lower surface 212 of the main cover 210 is open toward the bottom, and components may be assembled within the interior space of the main cover 210.

The main cover 210 may be formed of an insulating material, such as metal or high-strength plastic.

In addition, the main cover 210 may be provided with a grid-shaped heat dissipation surface 214, formed by thin flat plates that extend in one direction to intersect each other, on the outer surface of the main cover 210.

Alternatively, a coupling slot 216 to which at least one heat sink 300 is coupled may be formed in the outer surface of the main cover 210.

The insulating plate 240 is a plate-shaped structure configured to close the lower surface of the main cover 210 of the power relay assembly 200.

The insulating plate 240 may be formed of an insulator, and may be manufactured from a material having high thermal conductivity, if possible.

The insulating plate 240 may have a plurality of heat dissipation fins 242 formed on the upper or lower surface thereof to protrude in the direction of the surface, and may be provided with a series of patterns or unevenness formed to improve the assemblablity or coefficient of friction of the surface.

The main relay 220 is coupled to the inside of the main cover 210. In addition, the main relay 220 may be formed to be spaced apart from the inner surface (e.g., interior surface) of the main cover 210, and be coupled to the main cover 210 through first fasteners 270.

The first fasteners 270 are components that couple the main relay 220 and the main cover 210 to each other, and allows the main relay 220 and the main cover 210 coupled to each other to be insulated from each other.

The main relay 220 may also be configured so that the center of gravity thereof is biased toward the upper cooling plate 62 placed therebelow.

At least a portion of the busbar unit 230 may be accommodated in the main cover 210. In addition, a portion of the busbar unit 230 may be formed linearly along a predetermined path, and may protrude to the outside via the main cover 210 and the insulating plate 240.

The busbar units 230 are passages provided so that high-voltage current may flow therethrough, and the high-voltage current flow may be applied or stopped through the main relay 220.

The busbar units 230 are disposed at the lower end of the inner space of the main cover 210. In other words, the busbar units 230 may be placed at positions very close to the upper surface of the insulating plate 240, and a plurality of release pads 250 may be interposed between the upper surface of the insulating plate 240 and the lower surfaces of the busbar units 230.

The plurality of release pads 250 may be manufactured to have different shapes so as to correspond to structures formed in a complicated way between the insulating plate 240 and the busbar units 230.

The release pads 250 are formed of an insulator, and particularly, are formed of a material having high thermal conductivity to have a predetermined thickness and formed into a wide shape along a horizontal plane.

The second fasteners 280 include coupling units that couple the busbar units 230 and the main relay 220 at at least two positions.

The second fasteners 280 couple the busbar units 230 and the main relay 220 while maintaining electrical connection therebetween at coupling portions therebetween.

The second fasteners 280 may be configured to be located at low positions so as to be as close to the insulating plate 240 as possible within the space formed by the power relay assembly 200. In addition, the release pads 250 may be disposed at positions close to the second fasteners 280.

In the battery pack system 1 according to an embodiment of the present disclosure, positions where the second fasteners 280 are formed are points where the main relay 220 and the busbar units 230 are electrically connected to each other, and are main heating sources where strong heat generation frequently occurs.

Therefore, the second fasteners 280, the busbar units 230, and the main relay 220 that frequently generate heat in the power relay assembly 200 should be configured to be located as close to the upper cooling plate 62 as possible.

A plurality of third fasteners 290 is formed along the outer circumference of the main cover 210 to secure the power relay assembly 200 to the upper surface of the upper cooling plate 62.

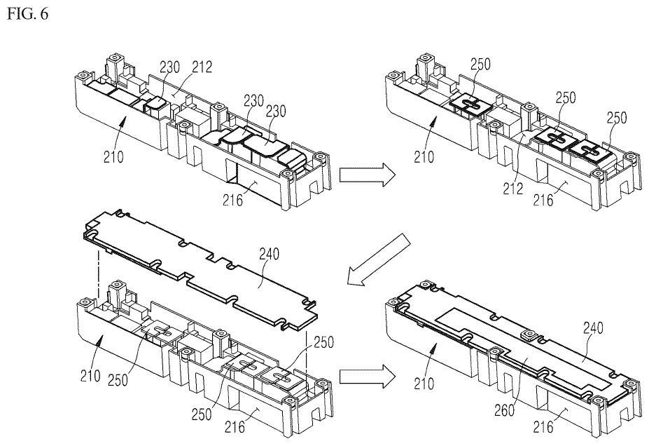

FIG. 6 is a diagram illustrating a process in which a plurality of thermal conductive layers is formed in the power relay assembly 200 in the battery pack system 1 according to an embodiment of the present disclosure.

As shown in FIG. 6, the main cover 210 may be placed so that the open lower surface 212 thereof faces upward. With reference to FIG. 6, in this orientation of the main cover 210, the interior of the main cover 210 is exposed.

The main relay 220, the busbar units 230, a fuse unit, a pre-charge unit, a temperature sensor, a current sensor, a PCB board, and the like may be assembled in sequence with the main cover 210 placed upside down so that the open surface thereof faces upward.

As illustrated, in the state in which all components are assembled with the main cover 210, the busbar units 230 are placed at the now upper end of the main cover 210 that forms the open surface of the main cover 210.

The plurality of release pads 250 respectively cut to fit the surrounding structures is placed on the now upper surfaces of the respective busbar units 230.

The insulating plate 240 is coupled to the main cover 210 to the open surface of the main cover 210 so that a predetermined surface pressure with the plurality of release pads 250 is formed.

In addition, a main pad 260 formed integrally to have a predetermined thickness is disposed on top of the insulating plate 240 (e.g., the bottom surface of the insulating plate 240).

The main pad 260 may have a predetermined size so as to cover most of the area of the bottom surface of the insulating plate 240.

The main pad 260 is also formed of an insulator, and has high thermal conductivity to facilitate rapid heat dissipation.

The power relay assembly 200 assembled as shown in FIG. 6 is now reoriented such that the insulating plate 240 faces the upper cooling plate 62. The power relay assembly 200 is coupled to the surface of the upper cooling plate 62 so that the insulating plate 240 and the main pad 260 face downward, as shown in FIGS. 3 and 4.

The main pad 260 is interposed between the insulating plate 240 and the surface of the upper cooling plate 62.

The battery pack system 1 according to an embodiment of the present disclosure having the above-described configuration is configured such that the main heating sources of the power relay assembly 200 are disposed as close to the upper cooling plate 62 as possible, and multiple materials having high thermal conductivity are placed in close contact with each other for rapid heat dissipation.

Accordingly, in order to suppress influence of high-voltage current flowing through the main relay 220 and the busbar units 230 on the components placed around the same, a plurality of insulating layers is provided to be stacked.

In the battery pack system 1 according to an embodiment of the present disclosure, the second fasteners 280, the busbar units 230, and the main relay 220, which are the main heating sources, are provided with at least three insulating films stacked between the same and the upper cooling plate 62.

Therefore, the main heating sources are configured so that the positions thereof are placed as low as possible for heat dissipation, thereby being capable of effectively suppressing weakening of the insulation effect that may be of concern.

It should be apparent from the above description, according to the present disclosure, a power relay assembly is cooled using cooling equipment equipped in a battery pack system, thereby being capable of overcoming an increased weight or a narrow space for additional device installation.

According to the present disclosure, busbar units, a relay unit, and coupling portions therebetween, which are main heating sources in the power relay assembly, are configured to be placed as close to the position of a cooling plate as possible, thereby being capable of increasing cooling efficiency.

According to the present disclosure, a height at which heavy parts are generally installed in the power relay assembly is lowered, thereby being capable of increasing structural stability.

The effects of the present disclosure are not limited to those mentioned above, and other effects not mentioned herein may be clearly understood by those having ordinary skill in the art from the above description.

The embodiments of the present disclosure have been described above. It should be apparent that the described embodiments and drawings are merely illustrative and may be variously modified within the technical scope of the present disclosure.

The described embodiments should be considered as a part of the present disclosure, and the scope of the present disclosure is not limited to these embodiments.

The scope of the present disclosure should be determined depending on the technical idea described in the claims.

In addition, it should be understood that, even if actions or effects according to a specific configuration are not explicitly described in the described embodiments, actions or effects capable of being predicted from the corresponding configuration are within the scope of the present disclosure.

What is claimed is:

1. A battery pack system comprising:
a cooling module provided on at least a portion of an outer surface of a battery housing, the cooling module comprising cooling plates;
a power relay assembly coupled to the battery housing so that an area of at least a portion of a surface of the power relay assembly comes into contact with the cooling plates; and
a main pad interposed between the power relay assembly and the cooling plates, the main pad comprising an insulating material having high thermal conductivity.

2. The battery pack system according to claim 1, wherein the power relay assembly comprises:
a main cover configured to have a hollow substantially rectangular parallelepiped shape and an open lower surface; and
an insulating plate coupled to a lower end of the main cover to close the open lower surface, the insulating plate being formed of an insulating material,
wherein the main pad has a predetermined thickness and is interposed between the cooling plates and a lower surface of the insulating plate.

3. The battery pack system according to claim 2, wherein the battery housing comprises:
a base plate having a lower surface;
a plurality of battery modules mounted at predetermined positions on an upper surface of the base plate;
a cover plate configured to cover upper portions of the plurality of battery modules to form an upper surface corresponding to the base plate; and
an upper cooling plate provided over a region of at least a predetermined area on an upper surface of the cover plate, the upper cooling plate being one of the cooling plates of the cooling module,
wherein the power relay assembly is coupled to an upper surface of the upper cooling plate such that the lower surface of the insulating plate faces the upper cooling plate.

4. The battery pack system according to claim 3, wherein the power relay assembly further comprises:
busbar units configured such that at least a portion of each busbar unit is housed within the main cover and arranged along a predetermined path;
a main relay coupled inside the main cover and configured to control a flow of high-voltage power through the busbar units; and
a plurality of release pads provided on an upper surface of the insulating plate, forming an insulating layer of a predetermined size, and composed of a material having high thermal conductivity.

5. The battery pack system according to claim 4, wherein the busbar units are defined as passages configured to allow high-voltage current to flow through.

6. The battery pack system according to claim 4, wherein the busbar units are in contact with upper surfaces of the plurality of release pads, such that the busbar units are positioned close to the upper cooling plate.

7. The battery pack system according to claim 6, wherein the main relay comprises:
a plurality of first fasteners configured to couple the main relay to the main cover such that the main relay is spaced from an interior surface of the main cover by a predetermined distance; and
a plurality of second fasteners, disposed closer to the upper cooling plate than the first fasteners, provided adjacent to the release pads to electrically connect the main relay and the busbar units.

8. The battery pack system according to claim 7, wherein the distance between the second fasteners and the upper cooling plate is less than a distance between the first fasteners and an upper end of the main cover.

9. The battery pack system according to claim 8, wherein at least three insulating layers, each formed of an insulating material, are disposed between the second fasteners and the upper cooling plate.

10. The battery pack system according to claim 2, wherein the main cover comprises:
a heat dissipation surface configured to have a grid-shaped heat dissipation structure by thin flat plates protruding from an outer surface of the main cover and intersecting each other;
a coupling slot on at least a portion of the outer surface; and
at least one heat sink configured to be detachably coupled to the coupling slot.

11. The battery pack system according to claim 2, wherein each cooling plate of the cooling plates of the cooling module comprises a refrigerant flow path on an inner surface, and configured to allow the refrigerant to flow along a predetermined passage.

12. The battery pack system according to claim 11, wherein the refrigerant flow path is configured such that, within a region where the power relay assembly is coupled to the cooling module, the refrigerant flow path has a higher complexity than in a surrounding area.

13. The battery pack system according to claim 1, wherein the cooling plates are configured to control the temperature of the battery pack system.

14. The battery pack system according to claim 1, wherein the cooling plates comprise an upper cooling plate coupled to an upper surface of a cover plate of a battery housing and a lower cooling plate coupled to a lower surface of a base plate of the battery housing.

15. A battery pack system comprising:
a cooling module provided on at least a portion of an outer surface of a battery housing, the cooling module being configured to control the temperature of the battery pack system;
a power relay assembly coupled to the battery housing so that an area of at least a portion of a surface of the power relay assembly comes into contact with the cooling module; and
a main pad interposed between the power relay assembly and the cooling module, the main pad comprising an insulating material having high thermal conductivity.

16. The battery pack system according to claim 15, wherein the power relay assembly comprises:
a main cover configured to have a hollow substantially rectangular parallelepiped shape and an open lower surface; and
an insulating plate coupled to a lower end of the main cover to close the open lower surface, the insulating plate being formed of an insulating material,
wherein the main pad has a predetermined thickness and is interposed between the cooling module and a lower surface of the insulating plate.

17. The battery pack system according to claim 16, wherein the cooling module comprise an upper cooling plate and a lower cooling plate,
wherein the upper cooling plate and the lower cooling plate each include a refrigerant flow path on an inner surface of the respective cooling plate, and
wherein the refrigerant flow path is configured to allow the refrigerant to flow along a predetermined passage.

18. The battery pack system according to claim 17, wherein the battery housing comprises:
a base plate having a lower surface;
a plurality of battery modules mounted at predetermined positions on an upper surface of the base plate; and
a cover plate configured to cover upper portions of the plurality of battery modules to form an upper surface corresponding to the base plate,
wherein upper cooling plate is provided over a region of at least a predetermined area on an upper surface of the cover plate, and
wherein the power relay assembly is coupled to an upper surface of the upper cooling plate such that the lower surface of the insulating plate faces the upper cooling plate.

19. The battery pack system according to claim 18, wherein the power relay assembly further comprises:
busbar units configured such that at least a portion of each busbar unit is housed within the main cover and arranged along a predetermined path;
a main relay coupled inside the main cover and configured to control a flow of high-voltage power through the busbar units; and
a plurality of release pads provided on an upper surface of the insulating plate, forming an insulating layer of a predetermined size, and composed of a material having high thermal conductivity.

20. The battery pack system according to claim 19, wherein the lower cooling plate is coupled to the lower surface of the base plate.
